(19) United States
(12) Patent Application Publication
(10) Pub. No.: US 2012/0289081 A1
(43) Pub. Date: Nov. 15, 2012

(54) DECORATIVE POWER OUTLET AND DEVICE CHARGING STATION STAND

(76) Inventor: Walter Izzard, Los Angeles, CA (US)

(21) Appl. No.: 13/107,805

(22) Filed: May 13, 2011

(51) Int. Cl. H01R 13/60

(52) U.S. Cl. 439/535

(57) ABSTRACT

The invention is a decorative tree shaped power outlet stand. The device provides power outlets and charging or communication ports through a hollow decorative stand. The outlets, universal serial bus (USB) ports, micro USB ports, mini USB ports, smart phone charging ports, and serial communication ports, are spaced apart on the stand to allow access to the power outlets from several directions. The outlets are spaced apart on the tree shaped stand so that large adapter plugs may easily be plugged in without interfering with or covering the other sockets. The tree has limbs or extensions that are flexible to slightly give under the weight of adapter plugs that are connected to the outlets on the extensions.

### FIELD OF THE INVENTION

The present invention relates to power outlets and device charging stations. Specifically, the invention relates to a decorative and portable power outlet and electronic device charging stand that has multiple spaced apart outlets.

### BACKGROUND

Currently, the need for multiple power outlets to charge electronic devices and power electrical appliances is prevalent. Most modern electronic are powered or recharged through bulky AC adapters that are plugged in to a power outlet. When multiple devices require multiple outlets, power strips are employed to provide multiple outlets for users to access the electrical power simultaneously from a single wall outlet. Standard power strips provide multiple female AC ports in a side-by-side manner. The resultant power strip is a horizontal row that can power standard-sized AC male plugs, however, when users need to plug in a more bulky AC adapter, the adapter may cover more than one female AC port or socket. Accordingly, those covered and unused sockets are wasted and not available to power other devices.

Several devices have been created to overcome this problem. For example, United States Patent Numbers (“USPN”) U.S. Pat. No. 6,486,407, issued to Hawker and the Powramid™, available at http://powramid.com/, disclose two different devices that are each designed to accommodate multiple large AC adapters, without having any of the ports covered by an adjacent adapter. The Hawker reference specifically discloses a multi-prong surge protector where the female power outlets have no fixed position within a common housing. The Powramid™ reference discloses a somewhat pyramidal-shaped power cone that has spaced apart outlets to accommodate large AC adapter plugs. Importantly, neither the Powramid™ nor the Hawker reference disclose a power stand that include decorative features, are designed to rest on a raised surface, such as a table, or include communication ports.

U.S. Pat. No. 7,144,610, issued to Estes, discloses a portable power stands that have multiple plugs. The Estes reference specifically discloses a somewhat tree shaped device that displays electrical Christmas ornaments. The device is essentially a support tube with a plurality of shelves wherein each of the shelves provides a electrical outlets along the circular shelf. The Estes disclosure requires that the shelves be immovable along a horizontal plane. The Estes reference does not disclose a decorative portable power stand. Additionally, the Estes stand is not designed to rest on a raised surface or include communication ports.

Regarding references that include communication ports, the Weener reference discloses a pedestal that provides a plurality of power and communication outlets wherein the columns underneath the pedestal encapsulates the wiring for the power outlets. But, Weener, is not decorative and does not disclose that the female electrical sockets may be positioned anywhere on the stand. Weener also fails to disclose a stand that is designed to rest on a raised surface.

Thus, what is needed is a power and communication station stand that has a plurality of spaced apart plugs in various locations on the stand, is decorative, and that is designed to rest on a raised surface.

### SUMMARY OF THE INVENTION

To minimize the limitations in the prior art, and to minimize other limitations that will become apparent upon reading and understanding the present specification, the present invention relates to a power outlet and communication port stand. Specifically, the device provides power outlets and charging or communication ports through a hollow decorative sculpture stand. The outlets, universal serial bus (USB) ports, mini USB ports, micro USB ports, smart phone charging ports, and serial communication ports, are preferably spaced apart on the stand to allow access and power from several directions, and without interfering with each other. The sculpture is preferably a tree or some other shape that has extensions, limbs, or branches that can act as power outlet locations. Preferably, the extensions are flexible to slightly give under the weight of adapter plugs that are connected to the outlets. This helps prevent damage to the stand when plugging or unplugging devices.

One embodiment of the invention is a decorative power outlet stand comprising: a plurality of power outlets; a body; a plurality of wires; a power cord; and a plurality of extensions. The extensions extend distally away from the body. The power outlets are located on the body and on the plurality of extensions and accept a plurality of AC adapters plugged into the plurality of power outlets without preventing access to any of the other plurality of power outlets. The power cord is connected to an external electrical outlet. The wires deliver electricity to the plurality of power outlets from the power cord. Preferably, at least one of the power outlets is located at a tip of one of the extensions. Preferably, the decorative power outlet stand also includes a base. The body is preferably mounted on the base. The base typically provides a substantially flat and stable surface for the body. The base is preferably adapted to rest on a flat and raised surface, such as a table. The decorative power outlet stand may also include one or more communications ports. The wires preferably deliver electricity to the communications ports from the power cord. The communications ports are preferably located at a top of the body. Preferably, the body and the extensions are substantially hollow to conceal the wires. Preferably, the base is weighted so the decorative power outlet stand is substantially prevented from tipping over. The extensions are preferably flexible. Preferably, the body is an artificial tree trunk and the extensions are artificial tree limbs, such that the decorative power outlet stand is a visual simulation of a tree. The decorative power outlet stand may include an on/off switch, a reset switch, and/or a surge protection device.

Another embodiment of the invention is a decorative power outlet stand comprising: a plurality of power outlets; one or more communications ports; a body; a plurality of wires; a power cord; and a plurality of extensions. The plurality of extensions extend distally away from the body. The power outlets are located on the body and on the extensions and accept a plurality of AC adapters plugged into the power outlets without preventing access to any of the power outlets. The power cord is connected to an external electrical outlet. The wires deliver electricity to the plurality of power outlets from the power cord. The body is an artificial tree trunk and the extensions are artificial tree limbs, such that the decorative power outlet stand is a visual simulation of a tree. Preferably, the artificial tree trunk and the plurality of artificial tree limbs are substantially hollow and wires are concealed within the artificial tree trunk and the artificial tree limbs. Preferably, at least one of the plurality of power outlets is located at a tip of one of the plurality of artificial tree limbs. The decorative power outlet stand may also include a base, upon which the artificial tree trunk is mounted. The base provides a substantially flat and stable surface for the artificial tree trunk. The base is preferably weighted so the decorative power outlet stand is substantially prevented from tipping over. The base is adapted to rest on a flat and raised surface, such as a table. The extensions are preferably flexible. Preferably, the communications ports are located at a top of the artificial tree trunk.

Another embodiment of the invention is a decorative tree shaped power outlet stand comprising: a plurality of power outlets; one or more communications ports; an artificial tree trunk shaped body; a plurality of artificial tree limb shaped extensions; a plurality of wires; a power cord; and a base. The artificial tree limb shaped extensions extend distally away from the artificial tree trunk shaped body. The power outlets are located on the artificial tree trunk shaped body and on the plurality of artificial tree limb shaped extensions and accept a plurality of AC adapters plugged into the plurality of power outlets without preventing access to any other of the plurality of power outlets. The power cord is connected to an external electrical outlet. The wires deliver electricity to the power outlets from the power cord. The decorative tree shaped power outlet stand is a simulation of a tree. The artificial tree trunk shaped body and the plurality of artificial tree limb shaped extensions are substantially hollow and wherein the plurality of wires are concealed within the artificial tree trunk shaped body and the plurality of artificial tree limb shaped extensions. At least one of the plurality of power outlets is located at a tip of one of the plurality of artificial tree limb shaped extensions. The artificial tree trunk shaped body is mounted on the base. The base provides a substantially flat and stable surface for the artificial tree trunk. The base is weighted so the decorative power outlet stand is substantially prevented from tipping over. The decorative tree shaped power outlet stand is adapted to rest on a flat and raised surface. The plurality of artificial tree limb shaped extensions are flexible. The communications ports are located at a top of the artificial tree trunk shaped body. Preferably, the decorative power outlet stand includes: an on/off switch; a reset switch; and a surge protection device.

In another embodiment the flexible limbs or extensions by be poseable.

It is an object of the present invention to provide a new and improved power strip or surge protector that is inexpensive, safe, decorative, and easy to use.

It is still another object of the invention to provide a plurality of power outlets on a table stand outlet tree that will accommodate a variety of AC adapters. As AC adapters vary more in shape and size, the invention discloses a configuration of power outlets that can accommodate extremely large and bulky AC adapters.

The power outlet stand of the present invention is to a vertically-enabled power strip that assists in distributing electricity to a plurality of power outlets. The stand is preferably substantially vertical, adapted to rest on a table, and provides power outlets in various vertical and horizontal positions on the stand. When AC adapters or male plugs are plugged in to the stand, the head of the AC adapter or male plug is kept off the ground. Because the stand is designed to be on a table or other raised surface, the plugs are much easier to access, than if the stand were on the floor.

The extensions, limbs, arms, or branches of the present invention are preferably hollow tubes that protrude and extend distally outward from a body or trunk of the stand. The tubes may be hollow coils or other flexible, yet sturdy fixtures that bend under slight pressure by a user, but will not break under the weight of an electronic device, plug, or AC Adapter.

It is an object of the present invention to overcome the limitations of the prior art.

Other features and advantages are inherent in the invention, as claimed and disclosed, will become apparent to those skilled in the art from the following detailed description and its accompanying drawings.

### BRIEF DESCRIPTION OF THE DRAWINGS

FIG. 1 is an illustration of a front view of one embodiment of the power stand.

FIG. 2 is an illustration of a back view of one embodiment of the power stand showing the stand in use.

FIG. 3 is an illustration of a side view of one embodiment of the power stand.

FIG. 4 is an illustration of a cut-away, front view of one embodiment of the power stand.

FIG. 5 is a detailed illustration of a top view of one embodiment of the power stand.

### DETAILED DESCRIPTION OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

The term “power outlets” refers to a female power outlet or electrical socket that is adapted to accept an electrical plug or AC adapter. Additionally, as with most power outlets that are understood in the art, the power outlets may be coupled with a surge protector. The surge protector may pass the electrical current to a ground wire if the voltage from the outlet surges or spikes above an acceptable level and a switch to selectively turn off the current to the power outlets.

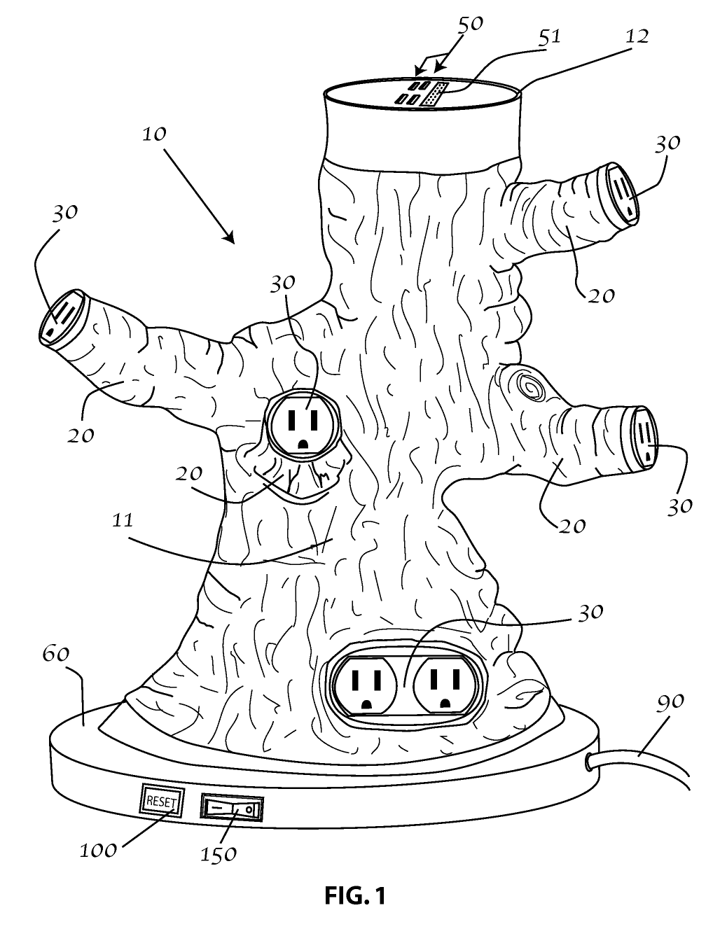

FIG. 1 is an illustration of a front view of one embodiment of the power stand. As shown in FIG. 1, the power stand 10 comprises a body 11, stand top 12, extensions 20, power outlets 30, communication ports 50 and 51, base 60, power cord 90, surge protector reset button 100, and on/off switch 150. Preferably, the power stand 10 is also a charging station for electrical devices. As shown in FIG. 1, power stand 10 has a plurality of power outlets 30 and communication ports 50 and 51, which include USB ports 50 and serial pin port 51. The power outlets 30 and communication ports 50 and 51 are preferably in various locations on the surface of the power stand 10. Although FIG. 1 shows the power outlets 30 and communication ports 50 and 51 at specific locations, it should be understood that any location may be used, so long as a plug, connector, or adapter can be plugged into the outlets or ports. FIG. 1 shows that some of the power outlets 30 are preferably located at the ends or tips of the extensions 20. Although extensions 30 are shown static, it is preferred that they are made out of a material that allows the extensions 30 to give, or bend slightly, with the weight of a plug, connector, or adapter. Extensions 20 may also be poseable or malleable, which allows the user to change the shape of the power stand 10 so that the power outlets are movable and more accessible. The power outlets 30 are preferably spaced apart so that a large AC adapter can easily plug into each power outlet without interfering with the other power outlets 30. The power outlets 30 are preferably located on both the body 10 and on extensions 20 and accept a several AC adapters plugged into power outlets 30 without preventing access to any other of said plurality of power outlets 30.

As shown in FIG. 1, the power stand 10 is preferably decorative and in the shape of a trimmed tree trunk or stump with branches. FIG. 1 shows that the artificial tree limb shaped extensions 20 preferably extend distally away from said artificial tree trunk shaped body 11.

In this manner, the power stand 10 is attractive and able to reside on the top of a table, rather than on the floor. FIG. 1 shows that the body 11 is a trunk and the extensions 20 are branches. Although a tree is shown in FIG. 1, it should be understood that any decorative shape or sculpture may be employed, including anthropomorphic shapes, animal shapes, or other types of plants.

FIG. 1 also shows that the power outlets 30 are spaced apart and able to accommodate adapters of all sizes, big and small. Figure one also shows that power stand 10 preferably has power outlets 30 on both the extensions 20 and body 11. Although standard U.S. two prong plus grounding power outlets 30 are shown, it should be understood that any shape or type of power outlet, port, or socket may be used without deviating from the scope of the invention.

FIG. 1 shows that power stand 10 may also include communications port 50 and 51. The communication port 51 is preferably a smart phone charging port, such as a 30 pin dock. Communication ports 50 are preferably USB, micro USB, or mini-USB, ports. Communication ports 50 may be in or out ports. As shown in FIG. 1, the communication ports 50 and 51 are on the stand top 12. This allows the user to rest a smart phone or other electronic device, on the stand top 12 and charge the smart phone at the same time. The stand base 60 may be comprised of any sturdy natural or man-made material that may serve as a platform for the power stand 10, including wood, metal, or plastic. Base 60 is preferably adapted to allow the stand to rest securely and attractively on a table, rather than the floor.

FIG. 1 shows that the stand 10 may have an on/off switch 150. This allows the user to cut power to all of the devices plugged into the power stand 10. As shown in FIG. 1, the stand 10 is preferably a surge protector and has reset button 100. The power cord 90 preferably plugs into a wall outlet and provides power to the power stand 10.

The base 60 is preferably weighted so the power stand is substantially prevented from tipping over. The base 60 preferably provides a substantially flat and stable surface for the stand, which allows the stand to be positioned on any flat raised surface, such as a table or desk.

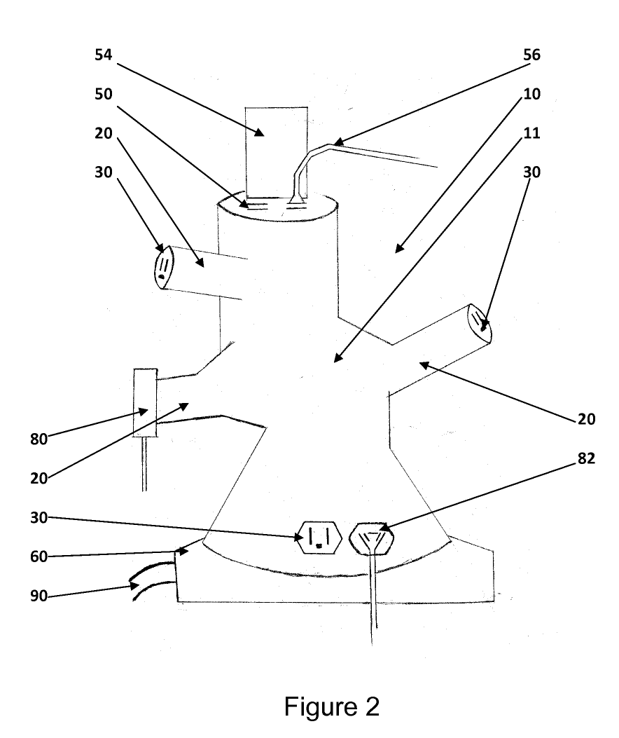

FIG. 2 is an illustration of a back view of one embodiment of the power stand showing the stand in use. As shown in FIG. 2, the power stand 10 preferably has a body 11, stand top 12, extensions 20, power outlets 30, communication ports 50 and 51, base 60, power cord 90. When in use, the power stand 10 preferably provides power from the power cord 90 to one or more electronic devices. The electronic devices may be plugged into any of the several power outlets 30 through an AC adapter 80 or have standard plug 82. FIG. 2 shows how an electronic device, such as a smart phone 54 may be charged directly in communication port 51. FIG. 2 also shows another electronic device plugged into one of the communication ports 50 through cord 56. The power stand 10 preferably is able to charge a plurality of electronic devices simultaneously without negatively affecting the charging of other electronic devices.

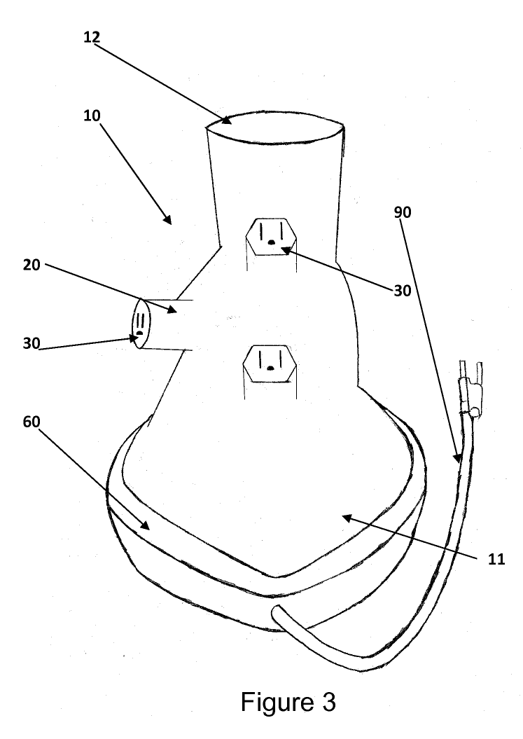

FIG. 3 is an illustration of a side view of one embodiment of the power stand. As shown in FIG. 3, the power stand 10 comprises a body 11, stand top 12, extensions 20, power outlets 30, communication ports 50 and 51, base 60, power cord 90. FIG. 3 shows another side of the attractive and decorative power stand.

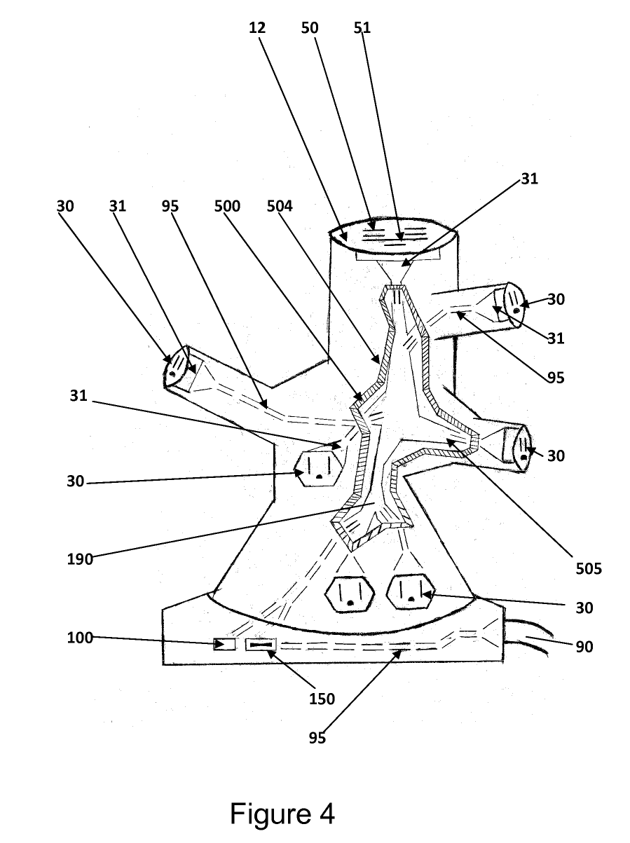

FIG. 4 is an illustration of a cut-away, front view of one embodiment of the power stand. As shown in FIG. 4, the power stand 10 comprises a body 11, stand top 12, extensions 20, power outlets 30, outlet bases 31, communication ports 50 and 51, base 60, power cord 90, surge protector reset button 100, on/off switch 150, wires 95, hollow interior 190, cut-away 500, decorative skin 504, and interior structure 505. FIG. 4 shows that the power stand 10 preferably has layers, including decorative skin 504 and interior structure 505 to enhance functionality. Internal structure 505 is preferably a flexible electrical grade support coil that encases the wires 95 as wires 95 run to the power outlets 30. These layers preferably support the weight that is added to the stand 10 when electronic devices and AC adapters are plugged into the charging stand 100. Figure one shows how decorative skin 504 preferably looks like bark. However, it should be understood that decorative skin 504 can be made to be any color or texture to simulate a variety of decorative embodiments, including an animal, a plant, an abstract structure, or a person. The decorative skin 504 may be constructed of any material, including, but not limited to, plastic, light metal, plaster, foam, putty, or other material that can cover the functional aspects of the stand 10. The decorative skin 504 allows the power stand 10 to be displayed in public as a decorative accessory. The decorative skin 504 may also be painted to make the power stand 10 look more like a tree or other object.

FIG. 4 shows how the stand is preferably substantially hollow, which allows wires 95 to move from the base 60 to the top 12 of stand 11, and to the ends of extensions 20. The wires 95 provide electricity to power outlets 30 and communication ports 50 and 51. The hollow interior 190 preferably conceals the wires within the stand 10.

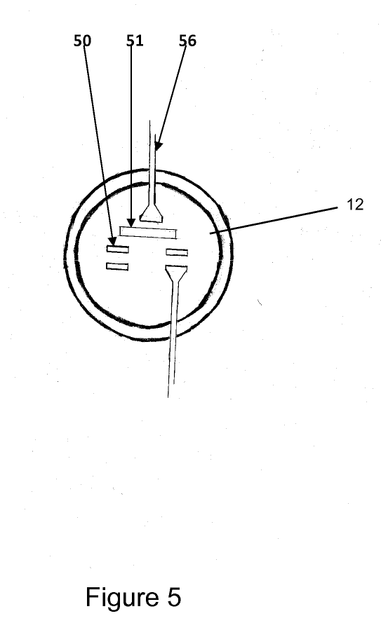

FIG. 5 is a detailed illustration of a top view of one embodiment of the power stand. As shown in FIG. 5, the top 12 of the stand preferably includes communication ports 50 and 51 that are accessible to electronic devices. The electronics devices are plugged into one of the communication ports 50 or 51 through cords 56.

In summary, the present invention is a device that provides spaced apart power outlets on a decorative stand.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A decorative power outlet stand comprising:
a plurality of power outlets;
a body;
a plurality of wires;
a power cord; and
a plurality of extensions;
wherein said plurality of extensions extend distally away from said body;
wherein said plurality of power outlets are located on said body and on said plurality of extensions and accept a plurality of AC adapters plugged into said plurality of power outlets without preventing access to any other of said plurality of power outlets;
wherein said power cord is connected to an external electrical outlet;
wherein said plurality of wires deliver electricity to said plurality of power outlets from said power cord.

2. The decorative power outlet stand of claim 1, wherein at least one of said plurality of power outlets is located at a tip of one of said plurality of extensions.

3. The decorative power outlet stand of claim 2, further comprising:
a base;
wherein said body is mounted on said base;
wherein said base provides a substantially flat and stable surface for said body;
wherein said base is adapted to rest on a flat and raised surface.

4. The decorative power outlet stand of claim 3, further comprising:
one or more communications ports;
wherein said plurality of wires deliver electricity to said one or more communications ports from said power cord.

5. The decorative power outlet stand of claim 4, wherein said one or more communications ports are located at a top of said body.

6. The decorative power outlet stand of claim 5, wherein said body and said plurality of extensions are substantially hollow and wherein said plurality of wires are concealed within said body and said plurality of extensions.

7. The decorative power outlet stand of claim 6, wherein said base is weighted so said decorative power outlet stand is substantially prevented from tipping over.

8. The decorative power outlet stand of claim 7, wherein said plurality of extensions are flexible.

9. The decorative power outlet stand of claim 8, wherein said body is an artificial tree trunk and wherein said plurality of extensions are artificial tree limbs, such that said decorative power outlet stand is a visual simulation of a tree.

10. The decorative power outlet stand of claim 9, further comprising:
an on/off switch.

11. The decorative power outlet stand of claim 10, further comprising:
a reset switch; and
a surge protection device.

12. A decorative power outlet stand comprising:
a plurality of power outlets;
one or more communications ports;
a body;
a plurality of wires;
a power cord; and
a plurality of extensions;
wherein said plurality of extensions extend distally away from said body;
wherein said plurality of power outlets are located on said body and on said plurality of extensions and accept a plurality of AC adapters plugged into said plurality of power outlets without preventing access to any other of said plurality of power outlets;
wherein said power cord is connected to an external electrical outlet;
wherein said plurality of wires deliver electricity to said plurality of power outlets from said power cord.

13. The decorative power outlet stand of claim 12, wherein said body is an artificial tree trunk and wherein said plurality of extensions are artificial tree limbs, such that said decorative power outlet stand is a visual simulation of a tree.

14. The decorative power outlet stand of claim 13, wherein said artificial tree trunk and said plurality of artificial tree limbs are substantially hollow and wherein said plurality of wires are concealed within said artificial tree trunk and said plurality of artificial tree limbs.

15. The decorative power outlet stand of claim 1, wherein at least one of said plurality of power outlets is located at a tip of one of said plurality of artificial tree limbs.

16. The decorative power outlet stand of claim 2, further comprising:
a base;
wherein said artificial tree trunk is mounted on said base;
wherein said base provides a substantially flat and stable surface for said artificial tree trunk;
wherein said base is weighted so said decorative power outlet stand is substantially prevented from tipping over;
wherein said base is adapted to rest on a flat and raised surface.

17. The decorative power outlet stand of claim 16, wherein said plurality of extensions are flexible.

18. The decorative power outlet stand of claim 17, wherein said one or more communications ports are located at a top of said artificial tree trunk.

19. A decorative tree shaped power outlet stand comprising:
a plurality of power outlets;
one or more communications ports;
an artificial tree trunk shaped body;
a plurality of artificial tree limb shaped extensions;
a plurality of wires;
a power cord; and
a base;
wherein said plurality of artificial tree limb shaped extensions extend distally away from said artificial tree trunk shaped body;
wherein said plurality of power outlets are located on said artificial tree trunk shaped body and on said plurality of artificial tree limb shaped extensions and accept a plurality of AC adapters plugged into said plurality of power outlets without preventing access to any other of said plurality of power outlets;
wherein said power cord is connected to an external electrical outlet;
wherein said plurality of wires deliver electricity to said plurality of power outlets from said power cord;
said decorative tree shaped power outlet stand is a simulation of a tree;
wherein said artificial tree trunk shaped body and said plurality of artificial tree limb shaped extensions are substantially hollow and wherein said plurality of wires are concealed within said artificial tree trunk shaped body and said plurality of artificial tree limb shaped extensions;
wherein at least one of said plurality of power outlets is located at a tip of one of said plurality of artificial tree limb shaped extensions;
wherein said artificial tree trunk shaped body is mounted on said base;
wherein said base provides a substantially flat and stable surface for said artificial tree trunk;
wherein said base is weighted so said decorative power outlet stand is substantially prevented from tipping over;
wherein said decorative tree shaped power outlet stand is adapted to rest on a flat and raised surface;
wherein said plurality of artificial tree limb shaped extensions are flexible;
wherein said one or more communications ports are located at a top of said artificial tree trunk shaped body.

20. The decorative power outlet stand of claim 19, further comprising:
an on/off switch;
a reset switch; and
a surge protection device.
